(19) United States
(12) Patent Application Publication
(10) Pub. No.: US 2022/0414608 A1
(43) Pub. Date: Dec. 29, 2022

(54) System for Dynamic Task Creation for Agricultural Equipment

(71) Applicant: Raven Industries, Inc., Sioux Falls, SD (US)

(72) Inventor: Jared Ernest Kocer, Sioux Falls, SD (US)

(21) Appl. No.: 17/846,542

(22) Filed: Jun. 22, 2022

Related U.S. Application Data
(60) Provisional application No. 63/214,104, filed on Jun. 23, 2021.

(51) Int. Cl. G06Q 10/10; G06Q 10/06; G06Q 30/02; G06Q 30/04; G06Q 30/06; G06Q 50/02

(52) U.S. Cl. CPC G06Q 10/1097; G06Q 10/06316; G06Q 10/063112; G06Q 10/063114; G06Q 30/0282; G06Q 30/04; G06Q 30/0645; G06Q 50/02

(57) ABSTRACT

A method may include receiving a request from a first user for a task to be completed on an agricultural field including an identification of the agricultural field, a piece of agricultural equipment for use on the agricultural field, and a date range for the task; generating a job data structure with the information in the request; executing a query to identify an operator for an available piece of agricultural equipment during the date range; transmitting a notification to a second user, the notification identifying request information, receiving confirmation the operator will complete the task and updating the job data structure based on the confirmation; in response to receiving a completion indication, transmitting a rating request for the piece of agricultural equipment; receiving, from the computing device, a rating for the piece of agricultural equipment; and updating an equipment listing for the second user with the rating.

### CROSS-REFERENCE TO RELATED APPLICATIONS

This patent application claims the benefit of priority, under 35 U.S.C. § 119(e), to U.S. Provisional Patent Application Ser. No. 63/214,104, titled “System for Dynamic Task Creation for Agricultural Equipment,” filed on Jun. 23, 2021, which is incorporated by reference in its entirety.

### BACKGROUND

When someone wants to rent a tool or piece of equipment, they generally will contact many different store/websites to determine if the tool is available and schedule a time to rent it. However, many times a person may not know precisely when they want to rent the tool because other tasks may need to be completed first, or on the day of the rental weather conditions may make it impossible to perform the intended task.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawing.

FIG. 1 is an illustration of elements of a client device and a task matching service, according to various examples.

FIG. 2 is a sample layout of a user interface of an equipment listing of a cooperative according to various examples.

FIG. 3 is a sample layout of a user interface of an equipment listing of farms, according to various examples.

FIG. 4 is an example visualization of how a job might be assigned, according to various examples.

FIG. 5 is a visualization of a map indicating availability, according to various examples.

FIG. 6 is a flowchart illustrating a method, according to various examples.

FIG. 7 is a block diagram illustrating a machine in the example form of a computer system, within which a set or sequence of instructions may be executed to cause the machine to perform any one of the methodologies discussed herein, according to various examples.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., RAM, cache, hard drive, or database store thereon) accessible by the component via an API or other program communication method. Similarly, the variables may be assumed to have respective default values should a specific value not be described. User interfaces may be provided for an end-user or administrator to edit the variable values in some instances.

In various examples described herein, user interfaces are described as being presented to a computing device. Presentation may include transmitting data (e.g., a hypertext markup language file) from a first device (such as a web server) to the computing device for rendering on a display device of the computing device via a rendering engine such as a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless indicated as such, the use of “presenting a user interface” does not inter either one of these options.

Additionally, the elements and portions are sometimes described as being configured for a certain purpose. For example, an input element may be described as being configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler, Thus, a “search” button element may be configured to pass text received in the input element to a search routine that formats and executes a structured query language (SQL) query with respect to a database

There are many times when a farmer may not have the agricultural equipment (e.g., a combine harvester, cultivator) they need to complete a job on one or more of their fields. Another farmer nearby may have the equipment but may not be aware of the other farmer's needs. In other instances, there may be operators that are looking to work, but they too may not be aware of any particular farmer's needs. Or a farmer may want to have help finishing a task faster and another farmer or operator may be able to help. In other examples, there may be retailers with equipment, but not enough operators. Consequently, there are many parties that are unable to match their needs with others, even if the equipment and personnel are available.

Traditional scheduling systems or job-matching systems are insufficient as they do not account for the complexity of farming jobs. For example, weather conditions, soil temperature, soil conditions, and field location are just some of the characteristics that may impact whether or not a job can be performed. Thus, the timing of a job is not static and therefore one cannot simply indicate a job is to be performed on this field on this date. Because of these (and other) particularities, described herein are technical improvements to scheduling systems to allow for matching and scheduling operators, farmers, equipment, and materials in order to complete jobs on farming fields. Electronic user interfaces are also improved to allow a user to define with particularity locations and job requirements, etc., that could not be done before. Additionally, by using reading from sensors placed around a geographic area, jobs may be dynamically assigned when the conditions are right for a job. Finally, the scheduling system may use autonomous vehicles to complete jobs for a farmer and communicate between themselves to assist in completing a job when another autonomous vehicle has broken down.

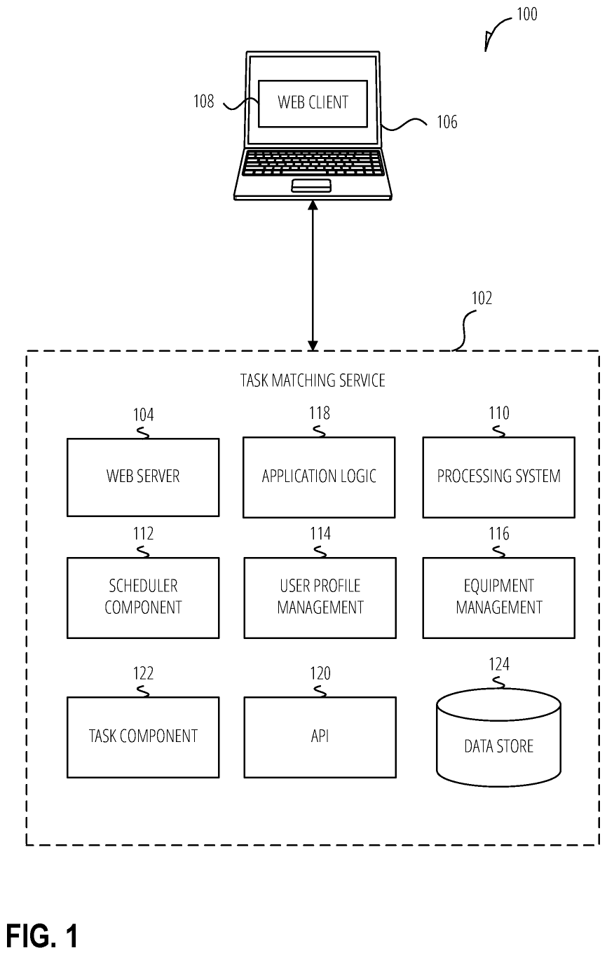

FIG. 1 is an illustration of components of user device 106 and task matching service 102, according to various examples. FIG. 1 includes task matching service 102, web server 104, user device 106, web client 108, processing system 110, scheduler component 112, user profile management 114, equipment management 116, application logic 118, API 120, task component 122, and data store 124. The components illustrated in FIG. 1 may be used to schedule a jib for a field in a variety of manners as discussed in more detail below.

User device 106 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information in the form of specially configured user interfaces). In some embodiments, computing devices may comprise one or more of a touch screen, camera, keyboard, microphone, or Global Positioning System (GPS) device.

In various examples, a user may refer to someone that interacts with task matching service 102 via a device such as user device 106. A user may have one or more roles. A role may be a farmer, an operator, a retailer, a cooperative, or a custom applicator in various examples. This disclosure may sometimes refer to the role instead of “user.”

User device 106 and task matching service 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

In some examples, the communication may occur using an application programming interface (API) such as API 120. An API provides a method for computing processes to exchange data. A web-based API (e.g., API 120) may permit communications between two or more computing devices such as a client and a server. The API may define a set of HTTP calls according to Representational State Transfer (RESTful) practices. For example, a RESTful API may define various GET, PUT, POST, DELETE methods to create, replace, update, and delete data stored in a database (e.g., data store 124). For example, an API call may be used to create or update a job in data store 124.

APIs may also be defined in frameworks provided by an operating system (OS) to access data in an application or sensor that an application may not regularly be permitted to access. For example, the OS may define an API call to obtain the current location of a device the OS is installed on such as location information of a piece of agricultural equipment. In another example, an application provider may use an API call to request a user be authenticated using a biometric sensor on the mobile device. By segregating any underlying biometric data. e.g., by using a secure element the risk of unauthorized transmission of the biometric data may be lowered. In another example, an API may be used to retrieve temperature readings from network-capable weather sensors.

Task matching service 102 is illustrated (and discussed below) as a set of separate elements with separate functions. However, the functionality of multiple, individual elements may be performed by a single element. An element may represent computer program code that is executable by processing system 110. The program code may be stored on a storage device (e.g., data store 124) and loaded into a memory of the processing system 110 for execution. Portions of the program code may be executed in a parallel across multiple processing units (e.g., a core of a general-purpose computer processor, a graphical processing unit, an application specific integrated circuit, etc.) of processing system 110. Execution of the code may be performed on a single device or distributed across multiple devices. In some examples, the program code may be executed on a cloud platform (e.g., MICROSOFT AZURE® and AMAZON EC2®) using shared computing infrastructure.

Task matching service 102 may include web server 104 to enable data exchanges with user device 106 via web client 108. Although generally discussed in the context of delivering webpages via the Hypertext Transfer Protocol (HTTP), other public network protocols may be utilized by web server 104 (e.g., File Transfer Protocol, Telnet, Secure Shell, etc.) or proprietary data transfer protocols (e.g., those used between industrial agricultural equipment) A user may enter in a uniform resource identifier (URI) into web client 108 (e.g., the INTERNET EXPLORER® web browser by Microsoft Corporation or SAFARI® web browser by Apple Inc.) that corresponds to the logical location (e.g., an Internet Protocol address) of web server 104. In response, web server 104 may transmit a web page that is rendered on a display device of a client device (e.g., a mobile phone, desktop computer, etc.).

Additionally, web server 104 may enable a user to interact with one or more web applications provided in a transmitted web page or as part of an application executing on user device 106 (e.g., a mobile app). In various examples, the web application is a task matching service as described in more detail below. A web application may provide user interface (UI) components that are rendered on a display device of user device 106. The user may interact (e.g., select, move, enter text into) with the LI components, and, based on the interaction, the web application may update one or more portions of the web page. A web application may be executed in whole, or in part, locally on user device 106. The web application may populate the UI components with data from external sources or internal sources (e.g., data store 124), in various examples.

The web application may be executed according to application logic 118, Application logic 118 may use the various elements of task matching service 102 to implement the web application. For example, application logic 118 may issue API calls to retrieve or store data from data store 124 and transmit it for display on user device 106. Similarly, data entered by a user into a UI component may be transmitted using API 120 back to web server 104. Application logic 118 may use other elements (e.g., scheduler component 112, user profile management 114, equipment management 116, task component 122, etc.) of task matching service 102 to perform functionality associated with the web application as described further herein.

Data store 124 may store data that is used by task matching service 102. Data store 124 is depicted as a singular element but may in actuality be multiple data stores. The specific storage layout and model used by data store 124 may take a number of forms indeed, a data store 124 may utilize multiple models. Data store 124 may be, but is not limited to, a relational database (e.g., SQL), non-relational database (NoSQL) a flat file database, object model, document details model, graph database, shared ledger (e.g., blockchain), or a file system hierarchy. Data store 124 may store data on one or more storage devices (e.g., a hard disk, random access memory (RAM), etc.). The storage devices may be in standalone arrays, part of one or more servers, and may be located in one or more geographic areas. Some of the data stored in data store 124 may include user profiles, job data structures, and agricultural equipment listings, among others.

As mentioned previously, task matching service 102 may implement a task matching service that may be used by users in a number of ways. A user that uses the task matching service may first register themselves with the service. User profile management 114 may provide user interfaces to users to create, update, or delete their profiles. For example, input UI elements may be presented on user device 106 to receive a username and password (e.g., credentials) and contact information (e.g., an email address, phone number) that are then stored in data store 124 as part of a user profile.

Through a series of additional UI elements, the user may enter in additional details. The details may vary depending on the role of the user. Accordingly, a user profile may include sections tailored to the various roles. A user may have multiple roles and thus fill out multiple sections of the user profile. A user profile may be stored as a data structure that is stored in data store 124. The data structure may include data fields for the sections discussed herein.

For example, for a farmer there may be sections where the farmer may enter in information about one or more of their fields such as location, size, current crop, etc., as well as how the farmer wants a field worked and what implement they would want for each type of task. In some examples, an interactive map may be presented on user device 106. The farmer may select (e.g., using an input device) an area on the map to define the field's location. The metes and bounds of the field may be stored as a series of GPS coordinates and associated with the field (e.g., part of a row in a database table).

Another section of the user profile may be an equipment listing. The equipment listing may identify the equipment that may be rented or used by another user. Multiple types of users may include an equipment listing such as farmers, dealers, and cooperatives. Equipment management 116 may assist the user in registering the equipment and tracking ratings for the equipment. For example, equipment management 116 may present a drop down menu or other UI elements on user device 106 in which a user may select a piece of equipment to register with their user profile. The drop downs may include options for a first type (e.g., irrigation, cultivation, planting, harvesting, tillage, etc.) and a sub-type depending on the first type (e.g., air seeder, broadcast seeder or tillage types: plow, chisel, ripper, field cultivator, etc.). Depending on the selection there may be checkboxes related to specific capabilities of the piece of equipment.

Additionally, a user may select a manufacturer, model, and year of the piece of equipment. In some examples, a user may enter in a model number and one or more the above (e.g., type, sub-type) may be pre-selected for the user. Data store 124 may include entries for the equipment. Accordingly, when a user enters in a model number, equipment management 116 may issue a query (e.g., an SQL query) to data store 124 to retrieve the information associated with the model number.

Another aspect of an equipment listing may identify what materials a user has on hand. For example, the user may have a variety of seeds, fertilizers, etc., that may be used. Accordingly, a user may register the materials as part of the equipment listing.

Another section of the user profile may be for operators. This section may include options for a user to identify the types of equipment the user/operator is qualified to operate or the user can provide, including autonomous agricultural equipment. The section may include UI elements that indicate when (e.g., April 1-10) the operator or equipment is available. Furthermore, the section may include options to define a service area that the operator/equipment is willing to travel to perform a job. The operator may include multiple entries for this section. For example, the operator may indicate that they are available within an X mile radius of a certain location for a certain date period. The operator may define the service area by selection on an interactive map, in various examples. A custom applicator may have a section similar to that of an operator. For example, the customer applicator may indicate the services that they are able to perform and the dates at which they will be in a certain area. In the context of this disclosure the use of “operator” may include the situation in which the operator is a processing unit of an autonomous piece of agricultural equipment.

Task component 122 may include logic to create a job with respect to a field. The terms task and job may be used interchangeably through this disclosure. A job may be represented by a data structure with a number of data fields. The data fields may include a job identifier, field identifier (e.g., an area as registered by a farmer needing help), a date/time the job is to be completed, an equipment identifier (e.g., a particular piece of equipment registered in a user profile), estimated time to complete, job parameter fields, materials needed, and completion status. The parameter fields may differ depending on the job type. For example; the job parameters may include a soil temperature, a planting depth, air temperature, moisture readings, what type of seeds/fertilizer to use, etc.

A job may be created in a number of manners and different data fields may be completed by different users and, in some instances, by automated processes of task matching service 102. For example, a user may log in to task matching service 102 using their credentials. In response, as part of the options presented to the user on user device 106, the user may select one of their registered fields and select an option that indicates work needs to be completed on the field. Upon selection of this option, task component 122 may generate a new job data structure and assign a job identifier (e.g., a unique number). The user may also enter in a date/time range the job should be completed and/or specific job parameters.

A search interface may be presented to the user to allow the user to select the equipment to use for the job. For example, the search interface may include filters for equipment type, equipment rating, equipment features (e.g., has a nozzle shutoff, how deep a tiller can go for fertilizer, etc.), availability (e.g., has not already been assigned to a job), and location. Thus, a farmer may select a cultivator that has a 5-star rating and that is within 5 miles of the selected field. In various example, the search interface may include a map that permits the farmer to select a specific entity (e.g., a local cooperative) and see their equipment listing. Accordingly, the farmer may select a particular piece of equipment from a particular entity to have it presumptively assigned to the job using its associated equipment identifier.

In some examples, a user may upload aerial photos of the land where the job is to take place. The user may also upload variable rate GPS maps that indicate the rate at which to apply chemicals, till, spread, plant, harvest, according to location. In other examples, task matching service 102 may receive aerial photos from unmanned aerial vehicles (UAVs) or from a networked service that has up-to-date images of the region.

In response to a job being created, one or more notifications may be issued to other users. For example, continuing the scenario above, a notification may be sent to the local cooperative requesting confirmation that the selected equipment may be used. Another notification may be sent to operators that may be able to operate the selected equipment in the time frame requested by the farmer (e.g., as determined by the operators' profiles).

Notifications may be transmitted in a number of ways. For example, the notification may be sent as a push notification to a user device 106. In other examples, the notification may be sent via e-mail. Each user may define one or more contact numbers or e-mail addresses in their user profile to receive the notifications. In some examples, the notifications may include options to confirm the equipment availability and/or acceptance of the job.

Scheduler component 112 may periodically (e.g., hourly) run to match up operators, equipment, and fields, Many jobs that may get created may not be able to be completed until certain conditions are met. For example, a farmer may indicate that a certain outside temperature is required for their job on their field. Scheduler component 112 may check the temperature at the field's location in a number of manners such as sending network requests to weather services or receiving temperature data from sensors located on or near (e.g., within a 5-mile radius or zip code) of the field. Sensor readings for other job requirements (e.g., humidity, soil temperature, max wind speed for spraying, etc.) may be received in a similar manner. When the conditions match the requirements of the job, scheduler component 112 may transmit notifications to users that have the required equipment for the job (assuming the farmer did not specify a specific piece of equipment) and available operators to complete the job.

In various examples, a future forecast (e.g., greater than one day out) may be used by scheduler component 112 to create an initial job and time for completing the job. Then, on the day the job is to be completed real-time conditions (or the current day's forecast) may be checked by scheduler component 112 to determine if there will be a long enough window of conditions that match the job requirements to complete the job. Checking the conditions may be include accessing sensors as described above. If the conditions are no longer acceptable for the spraying, planting, harvesting associated with the job, scheduler component 112 may reschedule the job for another date. If any matched equipment, operators, etc., is no longer available on the rescheduled date new matches may be made.

Scheduler component 112 may also be responsible for transmitting notifications to material providers to ensure that the materials needed for a job are sent to the field location at the time the job is to be completed.

Scheduler component 112 may also monitor how a job is progressing. For example, scheduler component 112 may receive data from agricultural equipment that identifies their location and estimated time of completion and diagnostic data (e.g., if the equipment has broken down). If the estimated time of completion is going to take longer than the originally requested time (e.g., due to mechanical problems) scheduler component 112 may transmit notifications to other users or autonomous vehicles that have the required equipment and available operators.

After a job has been completed, ratings may be received for the entities involved. For example, the farmer who requested the job may rate the overall job, the operator, and the piece of equipment. Task matching service 102 may then update the ratings for these entities. In various examples, the rating is a simple average of all the ratings whereas in other examples, more complex weightings may be used such as giving the most recent ten ratings more weight than the prior weights. In other examples, the ratings may be granularly applied and searched for based on field type, job type, etc. Thus, a user may be able to see (and search for) how a particular piece of equipment has performed for a certain type of job.

Other information may be gathered during the job that may be relayed to the farmer. For example, many types of equipment may collect data during a job such that may indicate a field's condition, presence of certain types of weeds, or infestations. The data may be transmitted to task matching service 102 where it may be stored as part of the job data structure and/or the owner of the field may be notified.

When an autonomous vehicle is used, task matching service 102 may suggest another job for the vehicle upon completion of the previously assigned job. For example, there may be an adjacent field that also needs work done and there has not been an assignment of equipment.

Task matching service 102 may facilitate payments to the various parties associated with a job. For example, an operator may be paid a wage based on the prevailing hourly rate in the region upon completion of the job if the equipment was rented, the equipment owner may also be paid. In various examples, an operator or equipment owner may set their or wage or rent prices. Task matching service 102 may also include or interface with a billing system to generate invoices related to the task. For example, an invoice may be generated transmitted to the farmer that requested the task, and then the payment on that invoice may be used to pay the operator and equipment owner.

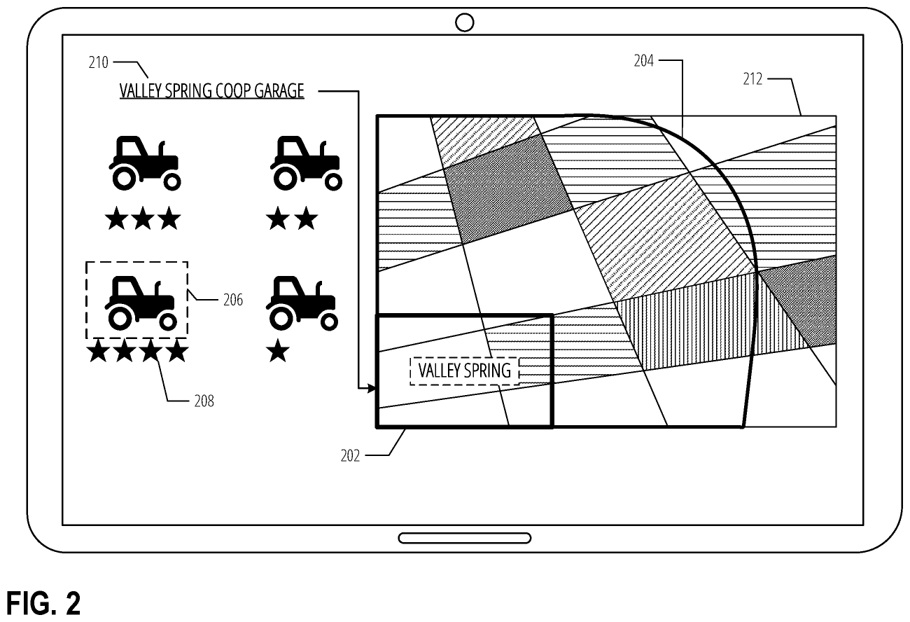

FIG. 2 is a sample layout of a user interface of an equipment listing of a cooperative according to various examples. FIG. 2 includes garage location 202, coverage area 204, equipment picture 206, equipment rating 208, garage identifier 210, and interactive map 212.

The user interface may be presented in a web page hosted by web server 104 on web client 108. The user interface of FIG. 2 may be part of a larger user interface. For example, a user may login to task matching service 102 using their stored credentials and be presented with a number of options related to features of task matching service 102, Among other features, task matching service 102 may present options to edit the user profile of the user to update their equipment listing, add or remove fields associated with the user, and create or edit existing jobs.

For one or more of the features, an interactive map such as interactive map 212 may be presented to the user. Interactive map 212 may be configured in different ways depending on the actions of the user. For example, interactive map 212 in FIG. 2 may be used by a user to explore the equipment listings of various farms, retailers, etc., in an area. A user may click on a region of a map such as garage location 202 to bring up an associated equipment listing for the garage identifier 210 and display coverage area 204. The equipment listing may present pictures of the equipment (e.g., equipment picture 206) and associated ratings (e.g., equipment rating 208).

In order to update interactive map 212 as depicted in FIG. 2, task matching service 102 may execute a number of database queries to data store 124, For example, when a user clicks on interactive map 212, the location within the map may be used as the basis for a query to retrieve the retailer, farm, etc., associated with that location as stored in a user profile. Then a query may be issued to retrieve the equipment listing and ratings for the equipment to present on the user interface.

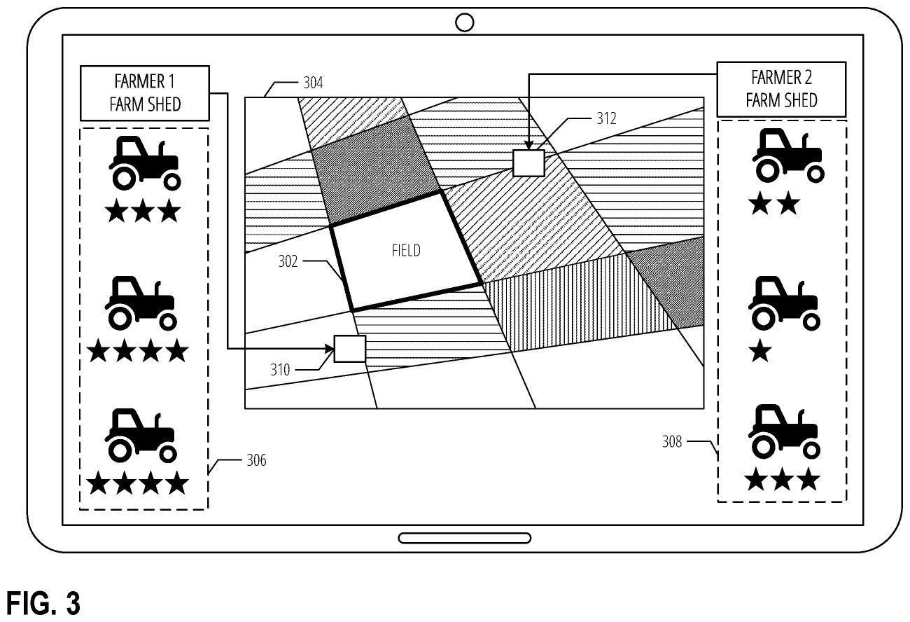

FIG. 3 is a sample layout of a user interface of an equipment listing of farms, according to various examples. FIG. 3 includes field 302, interactive map 304, equipment listing 306, equipment listing 308, farm 310, and farm 312, The user interface may be presented in a web page hosted by web server 104 on web client 108. The user interface of FIG. 3 may be part of a larger user interface as described above with respect to FIG. 2

A user may use a user interface such as presented in FIG. 3 to initiate a job. For example, a user may first click on field 302 to indicate to task matching service 102 that this is the field where the job is to be performed. The user may also click on different farms (e.g., farm 310 and farm 312) to see their respective equipment listings such as equipment listing 306 and equipment listing 308. The user may then click on a specific piece of equipment to indicate they would like to utilize that piece of equipment on the job. Although not illustrated, there may be a number of other data fields that the user can fill in with respect to the job (e.g., time, materials needed, etc.) as discussed above in the context of task component 122.

In response to the user selecting the equipment, task matching service 102 may transmit a request (e.g., a notification) to the owner of the equipment to confirm it is available. Upon receiving confirmation, task matching service 102 may update data store 124 to indicate that the particular piece of equipment is to be used for the job. Thus, if another user is searching for equipment to use at the same time as the aforementioned job, that particular piece of equipment would not show up as available.

In various examples, a user may only need to select field 302 and indicate the job parameters to initiate the job. Upon this initiation, task component 122 and scheduler component 112 may send out requests to operators and equipment owners to complete the job. Task component 122 may limit the requests based on distance, availability of the particular types of equipment needed, and sensor readings. In various examples, users may also search for farmers that are close to the field that is to be worked.

In various examples, a user (e.g., an operator) may use an interactive map (or a text-based search interface) to see fields that are currently in need of work. The user may then select the field and indicate they are available. A search interface may further permit filtering by the type of work that is being requested. In some instances, the user may also select a piece of equipment as described above. In other examples, task matching service 102 may transmit requests to equipment owners in the area.

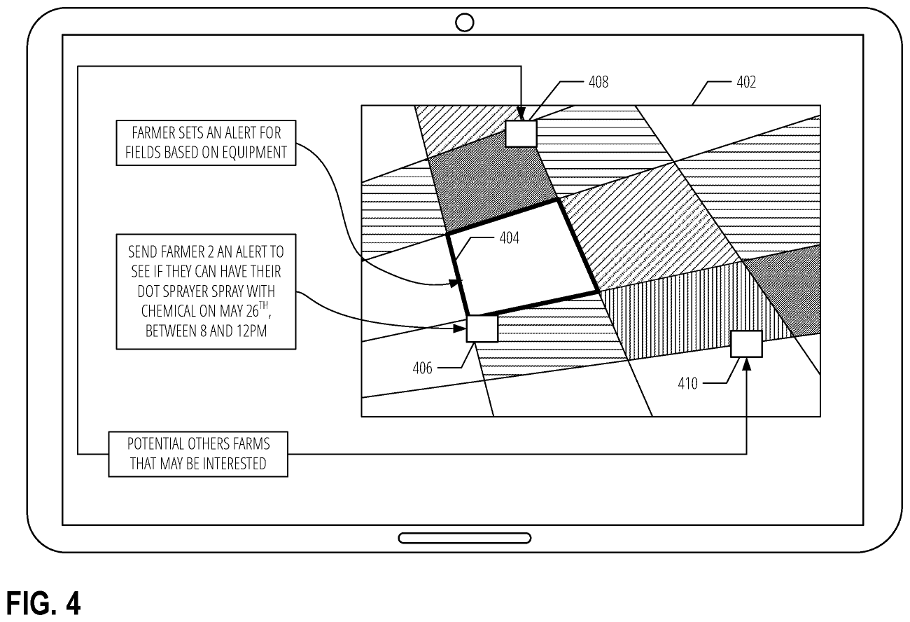

FIG. 4 is a visualization of how a job might be assigned, according to various examples. Consider that a first farmer selects field 404 on map 402 to indicate they want a job to be performed. Task matching service 102 may determine that farmer 2 (represented as farm 406) meets the criteria of the created job. As such, task matching service 102 may transmit an alert with the details of the job which in this case is for renting a DOT sprayer on May 26th between 8 and 12 PM. If farmer 2 accepts, the job entry in data store 124 may be updated. If not, requests may be transmitted to farmers associated with farm 408 and farm 410 to see if they can handle the job.

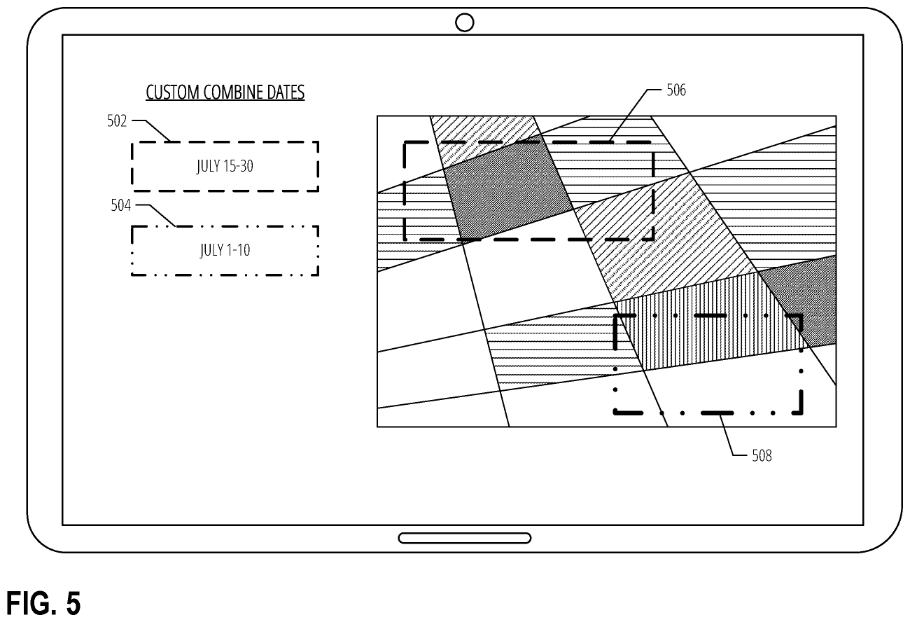

FIG. 5 is a visualization of a map indicating availability, according to various examples. A user may view a map just as presented in FIG. 5 to see the availability within certain regions for a custom combine. In this instance, the owner of the custom combine may have previously indicated their availability. For example, date range 502 shows that between July 15-30 the combine will be in geographic area 506 and date range 504 shows that between July 1-10 it will be in geographic area 508.

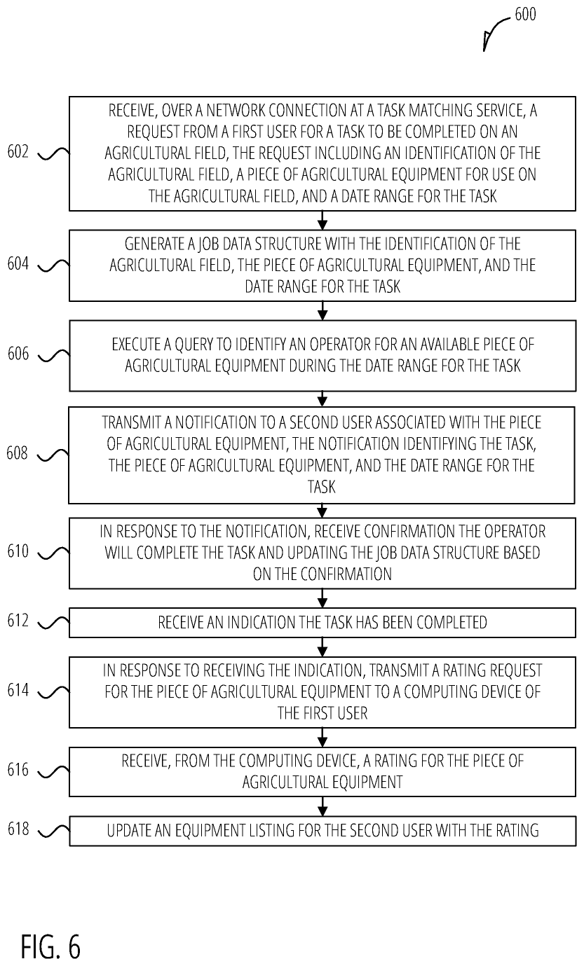

FIG. 6 is a flowchart illustrating a method 600, according to various examples. The method is represented as a set of blocks that describe operations 602-618 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 6. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure. In various examples, method 600 is performed using a system such as described for task matching service 102.

At block 602, method 600 includes receiving, over a network connection at a task matching service, a request from a first user for a task to be completed on an agricultural field, the request including an identification of the agricultural field, a piece of agricultural equipment for use on the agricultural field, and a date range for the task. The request may also identify any materials needed for the task. For example, the request may be based on information entered into forms on a website provided by task matching service 102 using an interactive map such as interactive map 212.

At block 604, method 600 includes, generating a job data structure with the identification of the agricultural field, the piece of agricultural equipment, and the date range for the task. Generating may include adding an entry to a database table stored in data store 124.

At block 606, method 600 includes executing a query to identify an operator for an available piece of agricultural equipment during the date range for the task. In some instance the operator may be a processing unit of the available piece of agricultural equipment. Executing a query may include using database query language (e.g., SQL) which returns results that match the parameters of the query. For example, the parameters include a data range and type of agricultural equipment.

At block 608, method 600 includes transmitting a notification to a second user associated with the piece of agricultural equipment, the notification identifying the task, the piece of agricultural equipment, and the date range for the task. In an example, the second user may be the owner of the piece of agricultural equipment. Transmitting may in form of an actionable (e.g., confirming or denying the task) push notification.

At block 610, method 600 includes in response to the notification, receiving confirmation the operator will complete the task and updating the job data structure based on the confirmation. For example, the response may be that a user clicked a “yes” option in the push notification or confirmed the job on a website provided by task matching service 102.

At block 612, method 600 includes receiving an indication the task has been completed. The indication may be received automatically from a piece of agricultural equipment or from a user. For example, if the piece of agricultural equipment is autonomous, the equipment may transmit the indication after a route of the task has been completed.

At block 614, method 600 includes in response to receiving the indication, transmitting a rating request for the piece of agricultural equipment to a computing device of the first user. In various examples, and further in response to the indication, an invoice may be generated and transmitted to the first user. For example, an API call may be transmitted to a billing system that generates the invoice and email s it to the first user. The billing system may use the current rates or a pre-agreed upon rate for the task.

At block 616, method 600 includes receiving, from the computing device, a rating for the piece of agricultural equipment.

At block 618, method 600 includes updating an equipment listing for the second user with the rating.

The computer-implemented method may also include where the request from the first user further includes an air temperature requirement for the task. The task could also include other field requirements (e.g., temperature) as discussed above.

The computer-implemented method may also include further includes receiving, over the network connection, a temperature reading from a sensor located on the agricultural field, determining the temperature reading meets the air temperature requirement for the task.

The computer-implemented method may also include where the transmitting the notification occurs based on the determining.

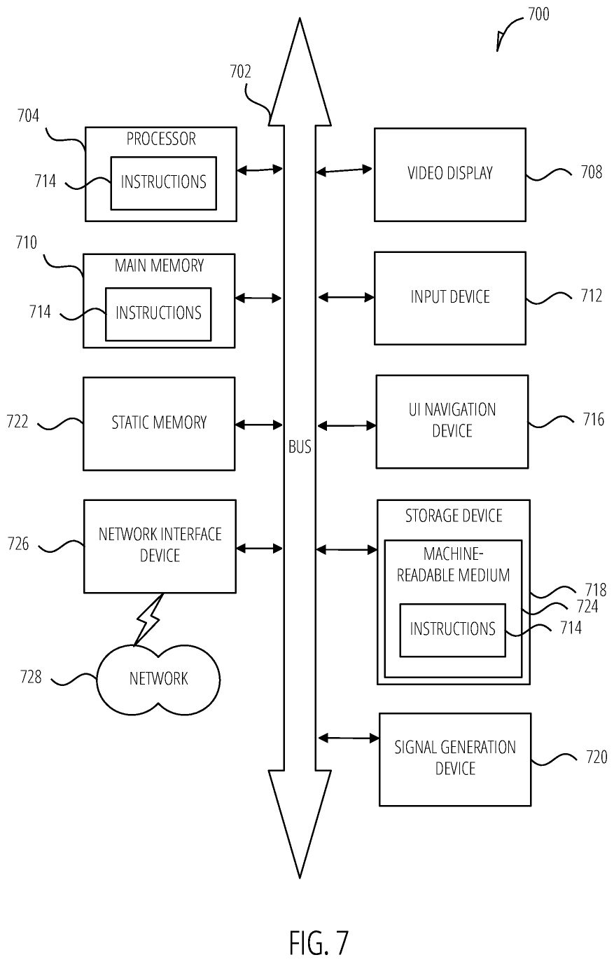

FIG. 7 is a block diagram illustrating a machine in the example form of computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 704 (e.g., a central processing unit (CPU), a graphics processing unit (GPU) or both, processor cores, compute nodes, etc.), a main memory 710 and a static memory 722, which communicate with each other via a bus 702. The computer system 700 may further include a video display 708, an input device 712 (e.g., a keyboard), and a user interface (UI) navigation device 814 (e.g., a mouse). In one embodiment, the video display 708, input device 712, and UI navigation device 716 are incorporated into a single device housing such as a touch screen display. The computer system 700 may additionally include a storage device 718 (e.g., a drive unit), a signal generation device 720 (e.g., a speaker), a network interface device 726, and one or more sensors (not shown), such as a global positioning system (GI'S) sensor, compass, accelerometer, or other sensors.

The storage device 718 includes a machine-readable medium 724 on which is stored one or more sets of data structures and instructions 714 (e.g., software) embodying or utilized by any one or more of the methodologies or functions described herein. The instructions 714 may also reside, completely or at least partially, within the main memory 710, static memory 722, and/or within the processor 704 during execution thereof by the computer system 100, with the main memory 710, static memory 722, and the processor 704 also constituting machine-readable media.

While the machine-readable medium 724 is illustrated in an example embodiment to be a single medium, the term “machine-readable medium” may include a single medium or multiple media (e.g., a centralized or distributed Database, and/or associated caches and servers) that store the one or more instructions 714. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 724 that excluded transitory signals.

The instructions 714 may further be transmitted or received over a communications Network 126 using a transmission medium via the network interface device 726 utilizing any one of a number of well-known transfer protocols (e.g., HTTP). Examples of communication networks include a local area Network (LAN), a wide area Network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein

What is claimed is:

1. A computer-implemented method comprising:
receiving, over a network connection at a task matching service, a request from a first user for a task to be completed on an agricultural field, the request including an identification of the agricultural field, a piece of agricultural equipment for use on the agricultural field, and a date range for the task;
generating a job data structure with the identification of the agricultural field, the piece of agricultural equipment, and the date range for the task;
executing a query to identify an operator for an available piece of agricultural equipment during the date range for the task;
transmitting a notification to a second user associated with the piece of agricultural equipment, the notification identifying the task, the piece of agricultural equipment, and the date range for the task;
in response to the notification, receiving confirmation the operator will complete the task and updating the job data structure based on the confirmation;
receiving an indication the task has been completed;
in response to receiving the indication, transmitting a rating request for the piece of agricultural equipment to a computing device of the first user;
receiving, from the computing device, a rating for the piece of agricultural equipment; and
updating an equipment listing for the second user with the rating.

2. The computer-implemented method of claim 1, wherein the request from the first user further includes an air temperature requirement for the task.

3. The computer-implemented method of claim 2, further comprising:
receiving, over the network connection, a temperature reading from a sensor located on the agricultural field; and
determining the temperature reading meets the air temperature requirement for the task.

4. The computer-implemented method of claim 3, wherein the transmitting the notification occurs based on the determining.

5. The computer-implemented method of claim 1, wherein the request from the first user further includes a soil temperature requirement and soil moisture requirement for the task.

6. The computer-implemented method of claim 1, wherein the request from the first user further identifies materials needed for the task.

7. The computer-implemented method of claim 1, further comprising:
in response to receiving the notification the task has been completed, generating an invoice; and
transmitting the invoice to the first user.

8. A system comprising:
a processor; and
a storage device storing instructions that, when executed by the processor, configure the system to:
receive, over a network connection at a task matching service, a request from a first user for a task to be completed on an agricultural field, the request including an identification of the agricultural field, a piece of agricultural equipment for use on the agricultural field, and a date range for the task;
generate a job data structure with the identification of the agricultural field, the piece of agricultural equipment, and the date range for the task;
execute a query to identify an operator for an available piece of agricultural equipment during the date range for the task;
transmit a notification to a second user associated with the piece of agricultural equipment, the notification identifying the task, the piece of agricultural equipment, and the date range for the task;
in response to the notification, receive confirmation the operator will complete the task and updating the job data structure based on the confirmation;
receive an indication the task has been completed;
in response to receiving the indication, transmit a rating request for the piece of agricultural equipment to a computing device of the first user;
receive, from the computing device, a rating for the piece of agricultural equipment; and
update an equipment listing for the second user with the rating.

9. The system of claim 8, wherein the request from the first user further includes an air temperature requirement for the task.

10. The system of claim 9, w, wherein the instructions, when executed by the processor, further configure the system to:
receive, over the network connection, a temperature reading from a sensor located on the agricultural field; and
determine the temperature reading meets the air temperature requirement for the task.

11. The system of claim 10, wherein the transmitting the notification occurs based on the determining.

12. The system of claim 8, wherein the request from the first user further includes a soil temperature requirement and soil moisture requirement for the task.

13. The system of claim 8, wherein the request from the first user further identifies materials needed for the task.

14. The system of claim 8, wherein the instructions, when executed by the processor, further configure the system to:
in response to receiving the notification the task has been completed, generate an invoice; and
transmit the invoice to the first user.

15. A non-transitory computer-readable storage medium, the computer-readable storage medium including instructions that when executed by a processor, cause the processor to:
receive, over a network connection at a task matching service, a request from a first user for a task to be completed on an agricultural field, the request including an identification of the agricultural field, a piece of agricultural equipment for use on the agricultural field, and a date range for the task;
generate a job data structure with the identification of the agricultural field, the piece of agricultural equipment, and the date range for the task;
execute a query to identify an operator for an available piece of agricultural equipment during the date range for the task;
transmit a notification to a second user associated with the piece of agricultural equipment, the notification identifying the task, the piece of agricultural equipment, and the date range for the task;
in response to the notification, receive confirmation the operator will complete the task and updating the job data structure based on the confirmation;
receive an indication the task has been completed;
in response to receiving the indication, transmit a rating request for the piece of agricultural equipment to a computing device of the first user;
receive, from the computing device, a rating for the piece of agricultural equipment; and
update an equipment listing for the second user with the rating.

16. The computer-readable storage medium of claim 15, wherein the request from the first user further includes an air temperature requirement for the task.

17. The computer-readable storage medium of claim 16, wherein the instructions, when executed by the processor, further cause the processor to:
receive, over the network connection, a temperature reading from a sensor located on the agricultural field; and
determine the temperature reading meets the air temperature requirement for the task.

18. The computer-readable storage medium of claim 17, wherein the transmitting the notification occurs based on the determining.

19. The computer-readable storage medium of claim 15, wherein the request from the first user further includes a soil temperature requirement and soil moisture requirement for the task.

20. The computer-readable storage medium of claim 15, wherein the request from the first user further identifies materials needed for the task.
